(19) United States
(12) Patent Application Publication
(10) Pub. No.: US 2013/0059474 A1
(43) Pub. Date: Mar. 7, 2013

(54) Conical Inductive Coupler

(71) Applicants: David R. Hall, Provo, UT (US); Scott Dahlgren, Alpine, UT (US); Jonathan Marshall, Provo, UT (US); Jerome Miles, Payson, UT (US)

(72) Inventors: David R. Hall, Provo, UT (US); Scott Dahlgren, Alpine, UT (US); Jonathan Marshall, Provo, UT (US); Jerome Miles, Payson, UT (US)

(21) Appl. No.: 13/226,723

(22) Filed: Sep. 7, 2011

(51) Int. Cl. H01R 13/40

(52) U.S. Cl. 439/625

(57) ABSTRACT

In one aspect of the present invention, an inductive coupling comprises a pin section and a box section. The pin section comprises an inner electrical conductor supported in an exterior tapered surface of the pin section. The box section comprises an outer electrical conductor supported in an interior tapered surface of the box section. The exterior and interior tapered surfaces are configured to align each other such that the interior and exterior tapered surfaces are coaxial with each other when fully engaged.

### CROSS REFERENCE TO RELATED APPLICATIONS

This application is a continuation in part of U.S. patent application Ser. No. 13/572,279 filed on Jun. 9, 2011. U.S. patent application Ser. No. 13/572,279 is herein incorporated by reference for all that it discloses.

### BACKGROUND OF THE INVENTION

The invention relates to the field of data transmission. More specifically, it relates to the field of downhole data transmission apparatuses.

U.S. Pat. No. 7,268,697 to Hall, et al., which is herein incorporated by reference for all that is contains, discloses a data transmission apparatus having first and second electrical conductors. The first and second electrical conductors are disposed within recesses of first and second complementary surfaces that are magnetically conducting and electrically insulating. The first and second surfaces are in close proximity to each other. The first surface is translatable along the length of the second surface. The first and second electrical conductors are in electromagnetic communication and provide for the transmission of data or power from the first electrical conductor to the second electrical conductor as the first surface overlaps the second surface. The data transmission apparatus may be located in one or more downhole tools.

U.S. Pat. No. 7,275,594 to Hall, et al., which is herein incorporated by reference for all that it contains, discloses a tool string stab guide used to axially align first tool string components with second tool string components. The stab guide has a body with an axial length along a longitudinal axis with a first and a second section. The first section of the body adapted for removable attachment within a diameter of a bore of a tool string component. The second section of the body has a centering element with a flow channel. The ratio of the axial length to the diameter is at least 2:1.

U.S. Pat. No. 6,670,880 to Hall, et al., which is herein incorporated by reference for all that it contains, discloses a system for transmitting data through a string of downhole components. The system includes first and second magnetically conductive, electrically insulating elements at both ends of the component. Each element includes a first U-shaped trough with a bottom, first and second sides and an opening between the two sides. Electrically conducting coils are located in each trough. An electrical conductor connects the coils in each component.

### BRIEF SUMMARY OF THE INVENTION

In one aspect of the present invention, an inductive coupling comprises a pin section and a box section. The pin section comprises an inner electrical conductor supported in an exterior tapered surface of the pin section. The box section comprises an outer electrical conductor supported in an interior tapered surface of the box section. The exterior and interior tapered surfaces are configured to align each other such that the interior and exterior tapered surfaces are coaxial with each other when fully engaged.

The inner and outer electrical conductors may be proximate each other such that they are in magnetic communication with each other when the interior and exterior tapered surfaces are fully engaged. The interior tapered surface may be configured to contact the exterior tapered surface. The interior surface may be configured to force the exterior tapered surface toward concentricity with the interior tapered surface. The exterior tapered surface may be configured to slide along the interior tapered surface with the interior and exterior tapered surfaces substantially flush. The exterior tapered surface may complement the interior tapered surface and the surfaces may experience a lowest potential energy when fully engaged.

The pin and box section may be configured to remain in magnetic communication with each other while they rotate relative to each other. The magnetic communication in the electrical conductors may be configured to transfer power from a downhole power generator to downhole equipment. In some embodiments, the outer electrical conductor may be configured to enter the box section and make direct electrical contact with the inner electrical conductor when the pin and box sections are fully engaged.

The inner electrical conductor supported by the exterior tapered surface may be in communication with surface equipment while the outer electrical conductor may be supported by the interior tapered surface is in electrical contact with downhole equipment.

The pin and box sections may comprise electrically insulating, magnetically conducting (MCEI) material configured to direct a magnetic field formed from the inner and/or outer electrical conductor toward an adjacent conductor. The MCEI material may be generally U-shaped.

The box section may be in mechanical communication with a mechanical member, the mechanical member configured to translate along a drill string to expand and/or contract an expandable tool. The box section may comprise a spring attached to a rearward end of the box section configured to push the box section onto the pin section to maintain the full engagement of the box and pin sections.

The box section may comprise an area where an outer diameter is smaller than other areas. The smaller diameter may be configured to bend the box section to fully engage the pin section when the pin section contacts the box section at an angle. The smaller diameter may be configured to axially re-center the box and pin sections to adjacent tool components after fully engaging the section.

The pin section may comprise an protruding guide, a first end of the extremity may be attached to a distal end of the pin section and a second end that is tapered and configured to help align the pin section and the box section.

### BRIEF DESCRIPTION OF THE DRAWINGS

FIG. 1 is a perspective view of an embodiment of a drill string.

FIG. 2a is a perspective view of an embodiment of an expandable tool.

FIG. 2b is a perspective view of another embodiment of an expandable tool.

FIG. 3a is a perspective view of another embodiment of an expandable tool.

FIG. 3b is a cross-sectional view of an embodiment of a coupling.

FIG. 4a is a perspective view of an embodiment of a pin section.

FIG. 4b is a perspective view of an embodiment of a box section.

FIG. 5a is a cross-sectional view of an embodiment of a conical coupler.

FIG. 5b is a cross-sectional view of another embodiment of a conical coupler.

FIG. 5c is a cross-sectional view of another embodiment of a conical coupler.

FIG. 6 is a cross-sectional view of another embodiment of a conical coupler.

FIG. 7a is a cross-sectional view of another embodiment of a conical coupler.

FIG. 7b is a cross-sectional view of another embodiment of a conical coupler.

FIG. 7c is a cross-sectional view of another embodiment of a conical coupler.

FIG. 8 is a cross-sectional view of another embodiment of a conical coupler.

FIG. 9a is a cross-sectional view of another embodiment of a conical coupler.

FIG. 9b is a cross-sectional view of another embodiment of a conical coupler.

FIG. 10 is a cross-sectional view of another embodiment of a conical coupler.

FIG. 11a is a cross-sectional view of another embodiment of a conical coupler.

FIG. 11b is a cross-sectional view of another embodiment of a conical coupler.

FIG. 11c is a cross-sectional view of another embodiment of a conical coupler.

FIG. 11d is a cross-sectional view of another embodiment of a conical coupler.

### DETAILED DESCRIPTION OF THE INVENTION AND THE PREFERRED EMBODIMENTS

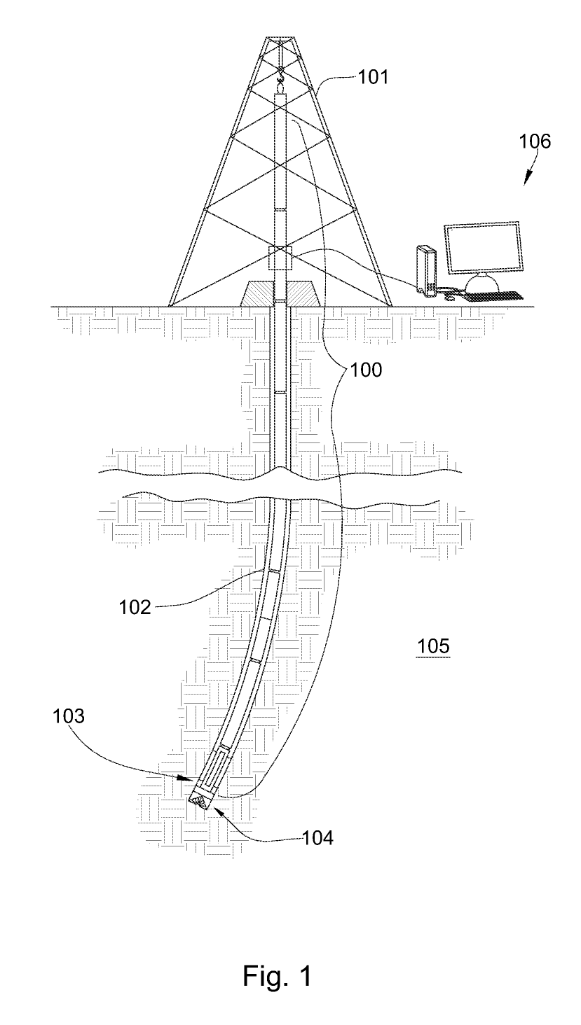

FIG. 1 discloses an embodiment of a drilling operation comprising a drilling derrick 101 supporting a drill string 100 inside a borehole 102. The drill string 100 may comprise a bottom hole assembly 103 that includes electronic equipment and an expandable tool 107. The expandable tool 107 may be configured to rotate in the borehole 102. Rotating the drill string 100 may also rotate a drill bit 104 and cause the drill bit 104 to degrade a bottom of the borehole 102. The drill string 100 may comprise equipment configured to steer the drill bit 104. Steering the drill bit 104 may result in bending the drill string 100.

The expandable tool 107 may ream a larger diameter in the borehole 102 than formed by the drill bit 104. In some embodiments, the expandable tool 107 may be configured to limit drilling vibrations by stabilizing the drill string 100. Information may be sent to and from the expandable tool 107 and/or bottom hole assembly 103 to electronic equipment 106 located at the surface.

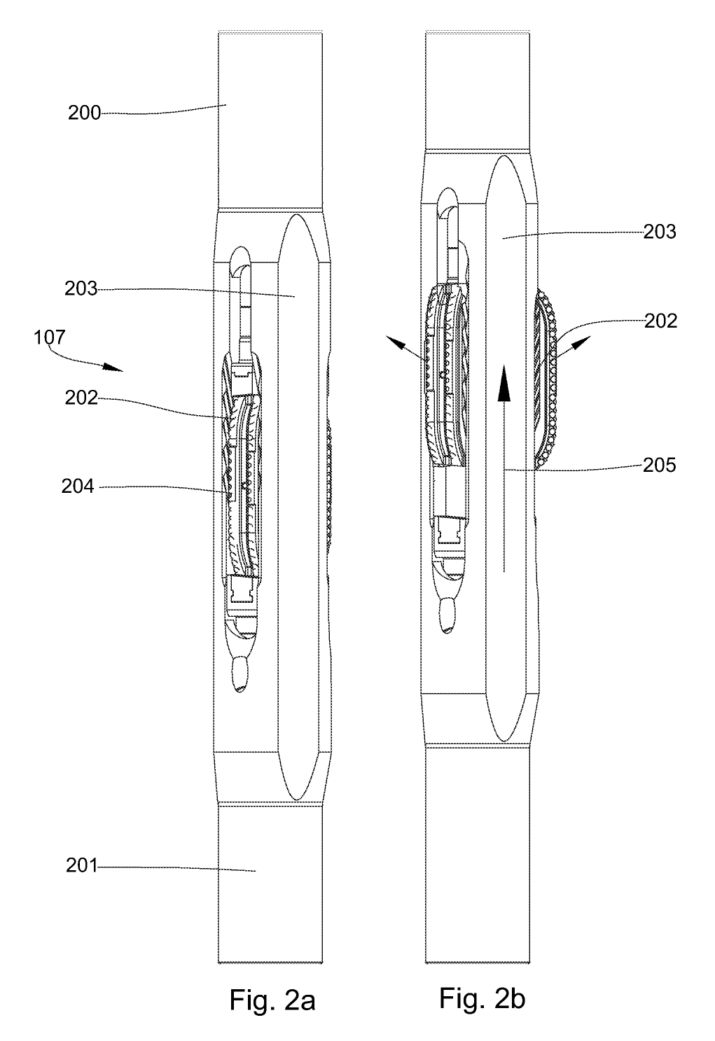

FIG. 2a discloses an embodiment of the expandable tool 107. A proximal end 200 of the expandable tool 107 may connect other downhole drill string components at tool joints. The tool 107 may connect directly to the bottom hole assembly 103, drill bit 104, or other drill string components. In this embodiment, the expandable tool 107 may comprise a mandrel with a tubular body and an outer surface, a plurality of blades 202 disposed around the mandrel's outer surface, and a slidable sleeve 203.

The slidable sleeve 203 comprises the plurality of blades 202 disposed in slots formed in the thickness of the sleeve's wall. A plurality of axial segments may form the slidable sleeve 203. The plurality of blades 202 may comprise a plurality of cutting elements 204 and may be configured to ream the borehole wall 102. The blades 202 in the embodiment of FIG. 2a are in a retracted position.

FIG. 2b discloses the slidable sleeve 203 configured to slide along an outer diameter of the expandable tool 107. The slidable sleeve 203 and the plurality of blades 202 may be connected such that as the slidable sleeve 203 slides along the expandable tool 107 in the direction of arrow 205, the plurality of blades 202 shifts laterally out of the slot. Sliding the sleeve 203 in the reverse direction may result in retracting the expandable tool 107. When the plurality of blades 202 is in an expanded position it may become engaged with a bore wall of an earthen formation 105.

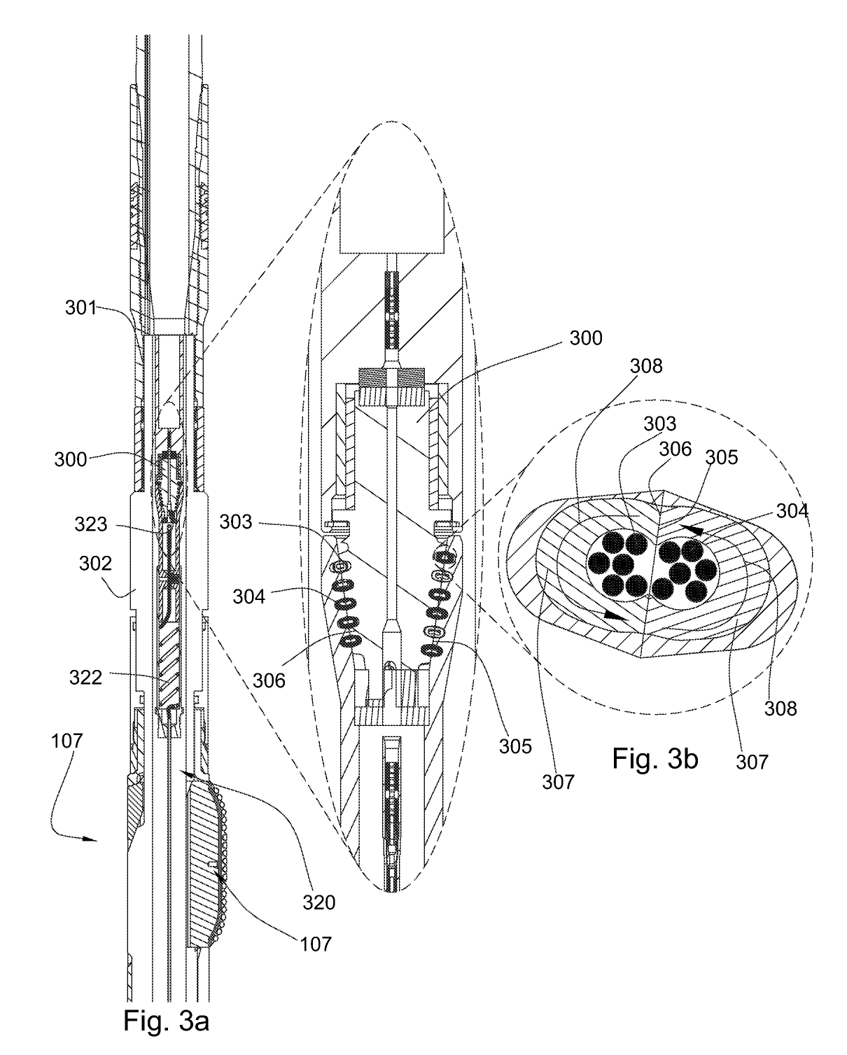

FIG. 3a discloses a conical coupler 300 disposed within the bore 102 of the drill string 100. The conical coupler 300 may be configured to pass signals from one tool component to an adjacent tool component. The signals may travel from the surface equipment 106 to downhole tool components and/or the drill bit 104. The conical coupler 300 comprises a pin section 301 and a box section 302. The pin section 301 comprises an inner electrical conductor 303 supported in an exterior tapered surface 306. The box section 302 comprises an outer electrical conductor 304 supported in an interior tapered surface 305. The interior and exterior tapered surfaces 305, 306 may be aligned such that the interior and exterior tapered surfaces 305, 306 are coaxial with each other when fully engaged.

The conical coupler 300 may be able to pass maximum signal strength when fully engaged. Fully engaging the sections 301, 302 may result when the pin section 301 is as close as possible to the box section 302 in a manner where the inner and outer electrical conductors 303, 304 are in magnetic communication with each other. The interior and exterior tapered surfaces 305, 306 may contact when fully engaged. The magnetic communication may be utilized to pass the signals from the pin section 301 to the box section 302.

The inner electrical conductor 303 may be in data and/or power communication with the surface equipment 106 or other equipment located in the drill string. The equipment 106 may send signals through the drill string 100 to command/control the drill bit 104 or other downhole tools. The signal may reach the pin section 301 and need to travel onto an adjacent member of the drill string. The signal may pass through the coupling 300 travelling on toward the drill bit 100 or other downhole tools.

The outer electrical conductor 304 supported by the interior tapered surface 305 may be in contact with downhole equipment. The outer electrical conductor 304 may pass a signal received from the inner electrical conductor 303 to the downhole equipment. Directing the downhole equipment through electrical signals in the drill string 100 may result in more efficient drilling.

The box section 302 may be in mechanical communication with a mechanical member 320. The mechanical member 320 may be in mechanical communication with the expandable tool 107 such that translating the mechanical member 320 along the drill string 100 may expand and/or contract the expandable tool 107. The expandable tool 107 may be directed to expand and/or contract through signals passed through the coupler 300 from the surface equipment 107.

The box section 302 may be attached to the mechanical member 320 through a spring 322 attached to a rearward end 323 of the box section 302. The spring 322 may be configured to extend when the expandable tool 107 is contracting and the mechanical member 320 is travelling away from the box section 302 and to retract when the expandable tool 107 is expanding and the mechanical member 320 is travelling toward the box section 302. The spring 322 may be configured to push the box section 302 onto the pin section 301 to maintain the full engagement of the box and pin sections 301, 302 before, during, and after translation.

In some embodiments a power source may be located downhole to provide local power for downhole equipment. The power may need to transfer between adjoining tool components. The electrical conductors may be configured to transfer power from a downhole generator to downhole equipment.

FIG. 3b discloses the fully engaged surfaces 305, 306 with the inner electrical conductor 303 in magnetic communication with the outer electrical conductor 304. The inner and outer electrical conductors 303, 304 may be surrounded by a magnetically conducting, electrically insulating (MCEI) material 307. Arrows 308 may disclose a direction of a magnetic field induced in the inner electrical conductor 303 by the signal passing through the conductor 303. The MCEI material 307 disposed within the exterior tapered surface 306 may direct the magnetic field into the MCEI material 307 disposed within the interior tapered surface 306, causing the outer electrical conductor 304 to have the same signal as the inner electrical conductor 303.

The MCEI material 307 may be formed into a generally U-shape. The U-shape may help the MCEI material 307 in the exterior tapered surface 305 to direct the magnetic field into the MCEI material 307 in the interior tapered surface 306 and the MCEI material 307 in the interior tapered surface 306 to receive the magnetic field and induce an electrical form of the signal in the outer electrical conductor 304.

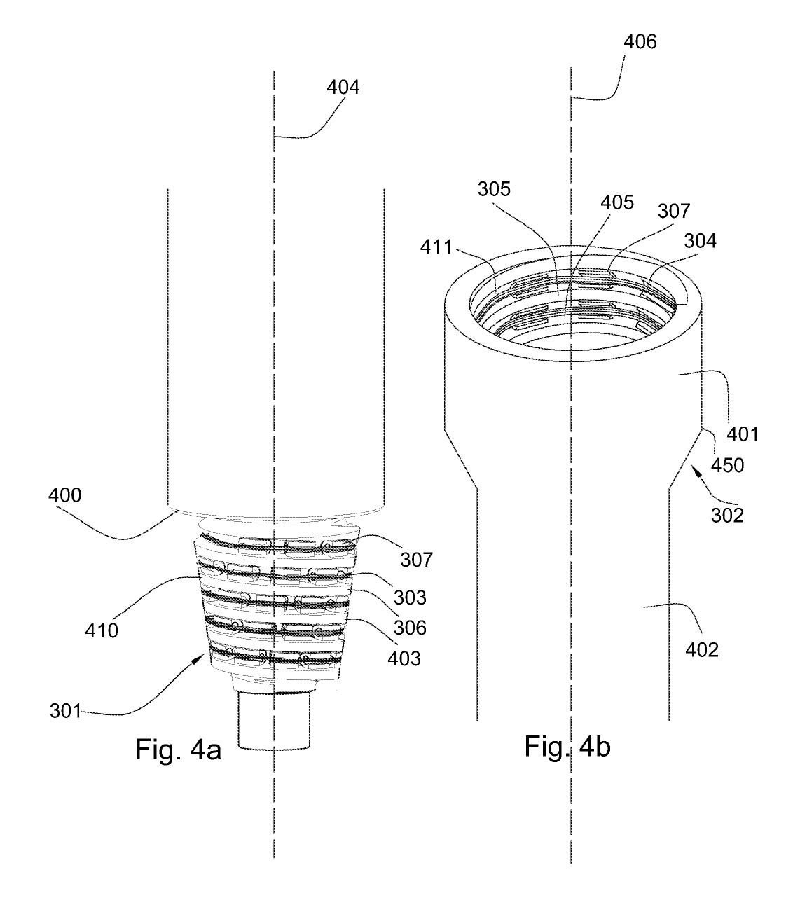

FIGS. 4a and 4b disclose an embodiment of the pin section 301 and the box section 302, respectively. The MCEI material 307 located in the interior 305 and exterior 306 tapered surfaces may be segmented. The pin section 301 may be located on a far end 400 of each tubular member in the drill string 100 while the box section 302 may be located on a near end 401 of each tubular member in the drill string 100. An outer diameter 450 of the tool member 402 may increase at the box section 302.

The exterior tapered surface 306 comprises an outermost diameter 410, and the surface 306 may comprise portions of the MCEI material 307, the inner electrical conductor 303, and an external sidewall 403.

The interior tapered surface 305 may comprise an outermost diameter 411, and the surface 305 may comprise portions of the MCEI material 307, the outer electrical conductor 304, and an internal sidewall 405. The interior and exterior tapered surfaces 305, 306 may be configured to mate with one another such that a close connection is achieved between the inner and outer electrical conductors 303, 304. The outer electrical conductor 304 may be configured to be flush with the interior tapered surface 305 and the inner electrical conductor 303 may be configured to be flush with the exterior tapered surface 306. Making the interior tapered surface 305 flush with the outer electrical conductor 304 and the exterior tapered surface 306 flush with the inner electrical conductor 303 may also allow the surfaces 305, 306 to slide along each other without getting snagged on each other.

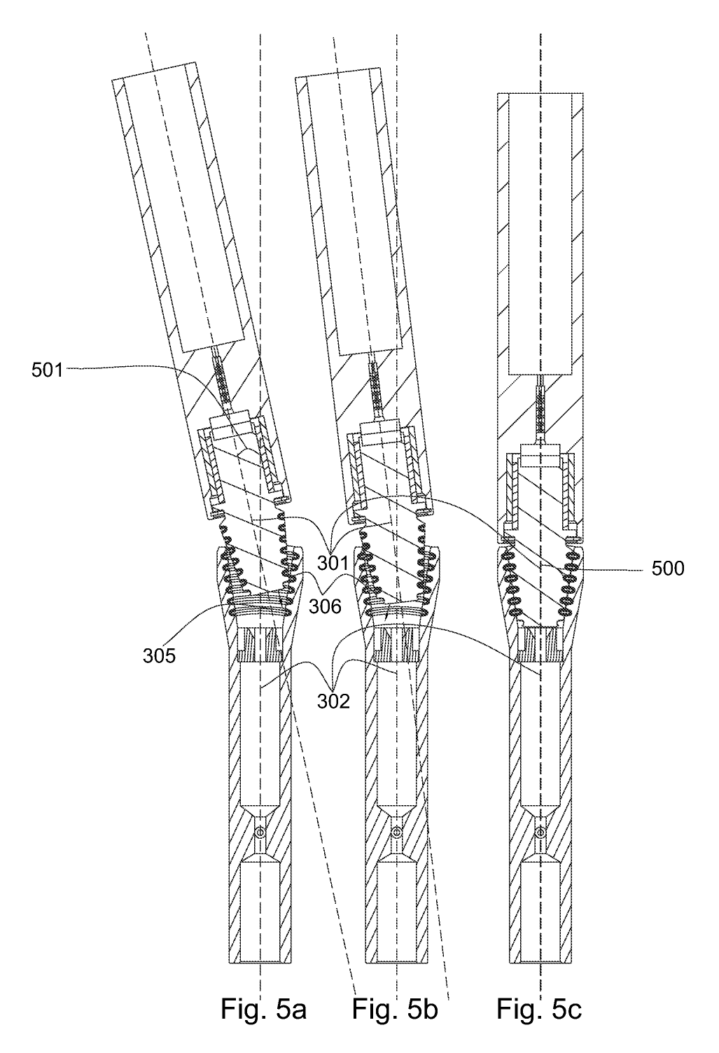

FIGS. 5a, 5b, and 5c disclose the pin section 301 contacting and progressively lining up with the box section 302. The inductive coupling 300 may become disengaged during drilling operations due to forces downhole separating the two sections, bending of the drill string 100, assembly or disassembly of the drill string, etc. While disengaged, the exterior 306 and interior 305 tapered surfaces may contact at discrepant angles 501. After contacting, the interior tapered surface 305 of the box section 302 may guide the exterior tapered surface 306 of the pin section 302 to align and become fully engaged.

An angle 500 on the interior and exterior surfaces 305, 306, with regards to the axes 404, 406 of the components, may be conducive to aligning the axes 404, 406 of the components. A load applied to the pin and box sections 301, 302 may push the sections 301, 302 together. The load may force the pin section 301 toward the box section 302; the interior tapered surface 305 may guide the descending pin section 301 into the box section 302. The exterior tapered surface 306 may be configured to slide along the interior tapered surface 305. The interior tapered surface 305 may force the exterior tapered surface 306 towards alignment with the interior tapered surface 305.

The pin and box sections 301, 302 may become fully engaged to pass the strongest signal possible across the coupling 300. The exterior tapered surface 306 may complement the interior tapered surface 305 such that the pin and box sections 301, 302 experience the lowest potential energy when fully engaged. Fully engaging the pin and box sections 301, 302 may result in the pin section 301 resting on the box section 302.

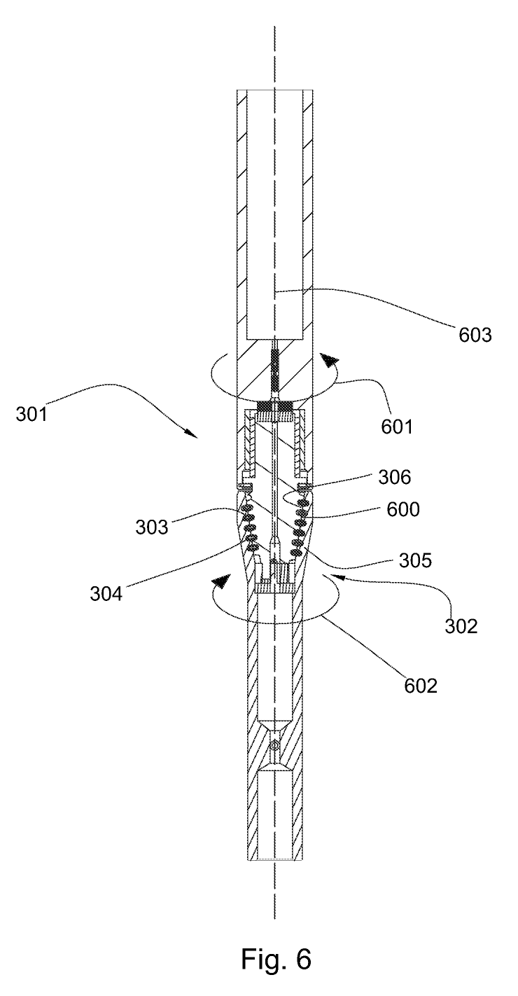

FIG. 6 discloses the fully engaged conical coupler 300. The pin and box sections 301, 302 may be configured to rotate with respect to each other as disclosed by arrows 601, 602. The sections 301, 302 may rotate about an axis 603 of the drill string 100. The pin section 301 may be encircled by, and fully engaged with, the box section 302 during and after rotation. Due to the conical shape of the interior and exterior tapered surfaces 305, 306, the inner and outer electrical conductors 303, 304 may continually remain proximate each other during rotation. This may allow the inner electrical conductor 303 to continuously be in magnetic communication with the outer electrical conductor 304 during rotation.

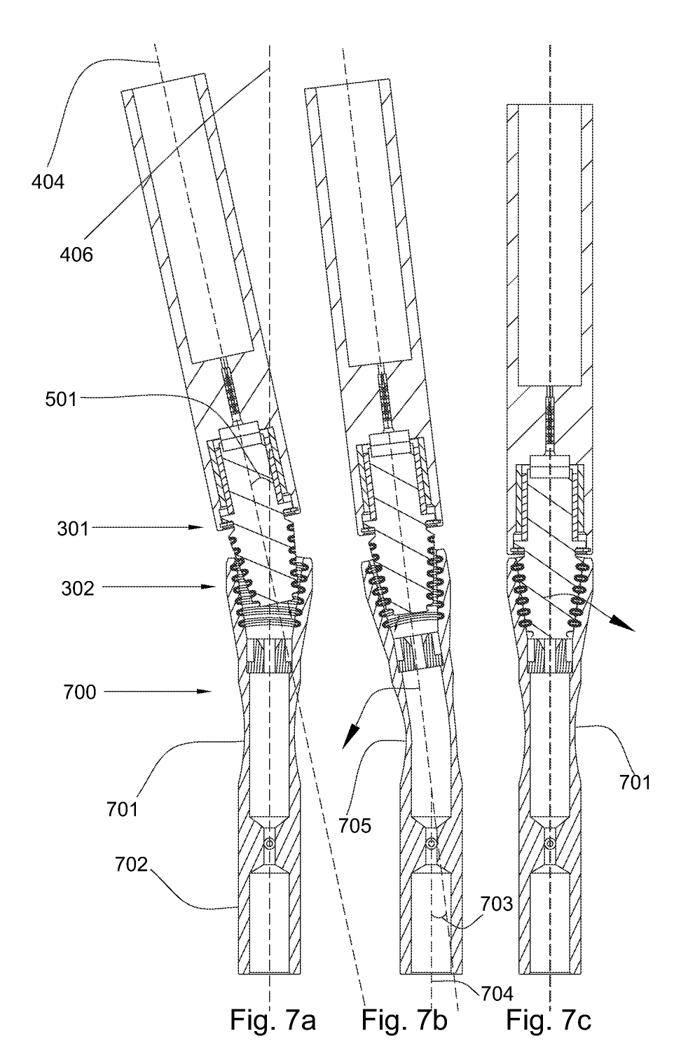

FIGS. 7a, 7b, and 7c disclose the pin section 301 and an adjacent tool component 700 attached to the box section 302. The adjacent tool component 700 may be located further in the borehole 102 from the surface equipment 106 than the coupling 300. The adjacent tool component 700 may be configured to elastically deform to accommodate the alignment of the members. Elastic properties of the adjacent tool component 700 may help the axes 404, 406 of the pin and box sections 301, 302 to align with axes of other tool components in the drill string 100 with lower energy and, in some situations, with minimal damage.

The adjacent tool component 700 may have a reduced diameter section 701 that is configured to bend as the members are aligning. The pin section 301 may contact the box section 302 and the load on the pin and/or box sections 301, 302 may force the box section 302 to align with the pin section 301. Subsequent loads may force the pin and box sections 301, 302 closer and fully engage the pin section 301 at an angle 703 from the axis 704 of the drill string 100. Straightening the pin and box sections 301, 302 may re-center the box and pin sections 302, 301 with the surrounding tool components.

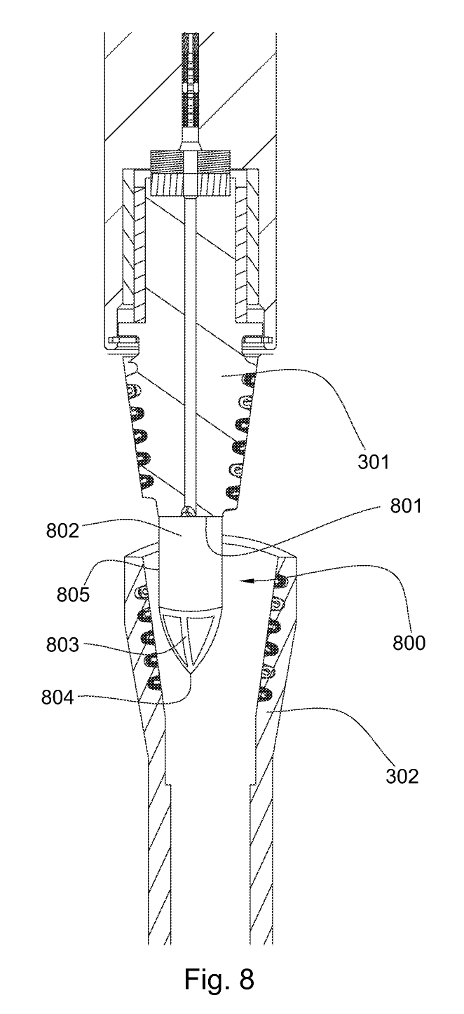

FIG. 8 discloses the pin section 301 comprising a protruding guide 800 attached to the pin section 301 that is configured to move the pin section such that the shoulders of the pin and box section avoid collision during alignment. The protruding guide 800 may be attached to a distal end 801 of the pin section 301. A base end 802 of the guide 800 may attach to the distal end 801 of the pin section 301 and a leading end 803 may taper at an appropriate angle to sufficient center the pin section within the box section as the sections align.

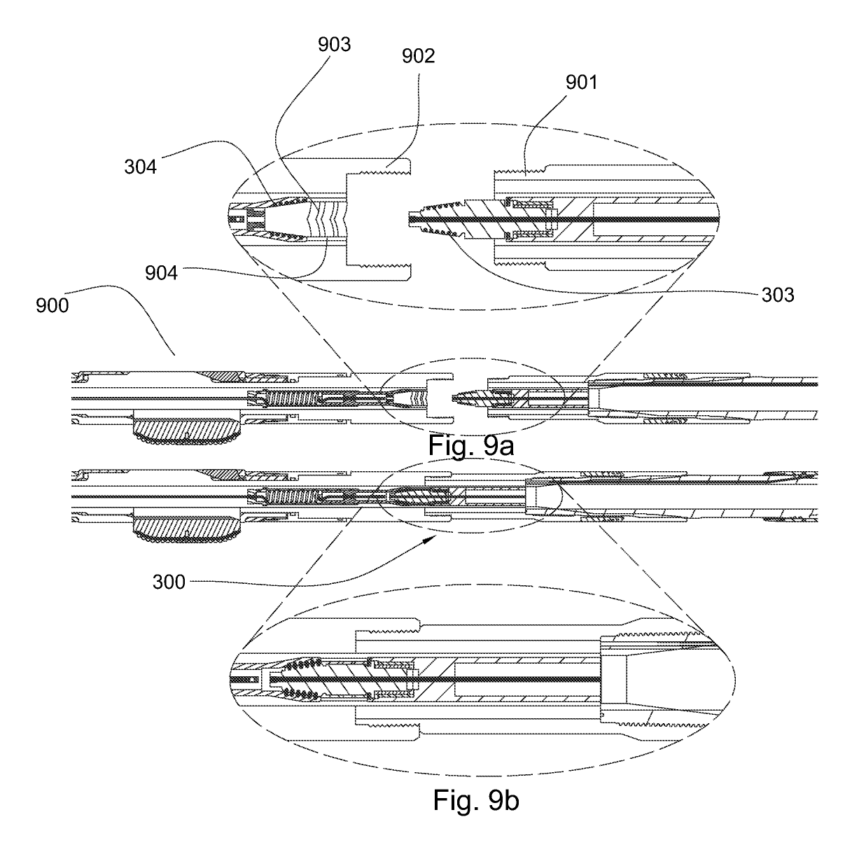

FIGS. 9a and 9b disclose a conical coupler 300 centralized within a tool string 900. The coupler 300 comprises an extending pin section 901 and the box section 302 comprising a neck 902 and wipers 903. The extended pin section 901 may be extended to help the pin section 301 fit into the neck 902 set into the box section 302. The neck 902 may be set into the box section 302 such that the wiper 903 is attached to an inner diameter 904 of the neck 902 configured to clean oil, mud, shavings, dirt, and/or combinations thereof off of the pin section 301. Cleaning the pin section 301 may allow the inner and outer electrical conductors 303, 304 to be closer together when fully connected. The clean conductors 303, 304 may be able to make a direct electrical connection, adding strength to passing signals.

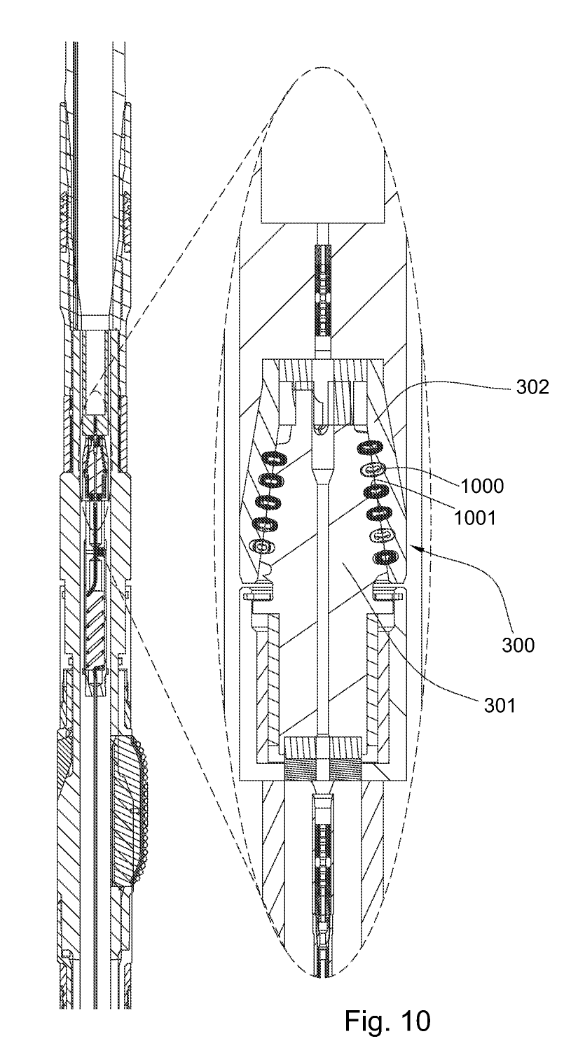

FIG. 10 discloses a box and pin sections 301, 302. In some embodiments, the box section 302 may be connected to surface equipment 106 and/or the downhole generator and the pin section 301 may be connected to downhole tools and/or the drill bit 104.

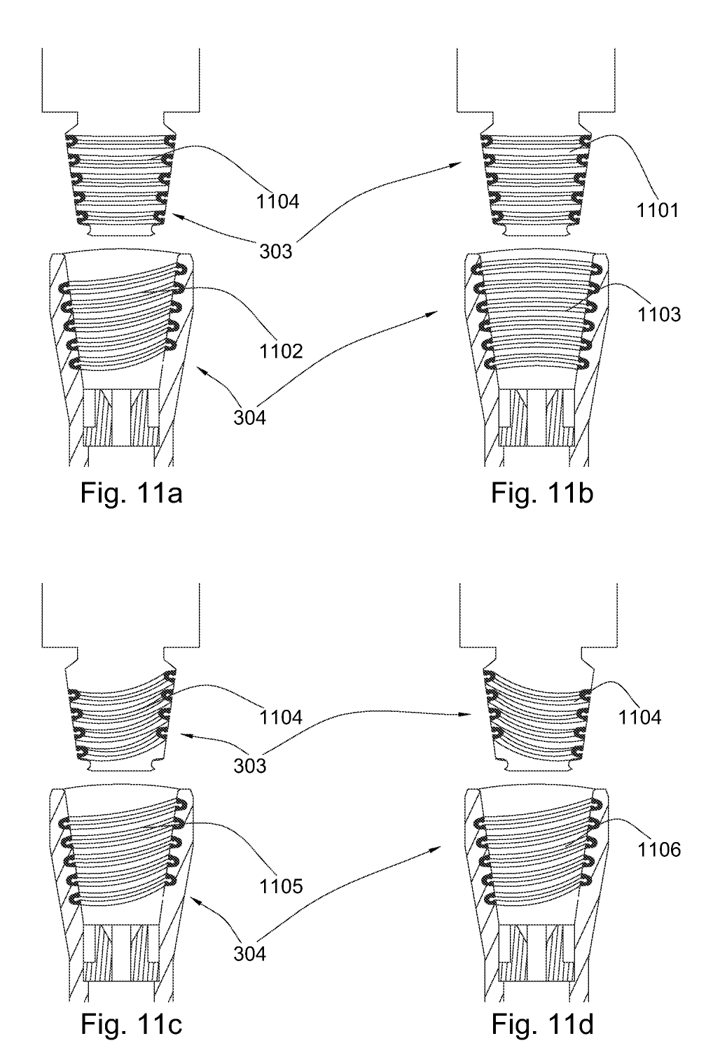

FIGS. 11a, 11b, 11c, and 11d disclose alternative windings 1101-1106 of the inner and outer electrical conductors 303, 304. The inner conductor 303 may be toroidally wound 1101 with the outer conductor helically 1102 or toroidally wound 1103. The inner conductor 303 may be helically wound 1104 with the outer conductor 304 helically wound a same direction 1105 or transverse direction 1106. The alternative windings 1101, 1102, 1103, 1104, 1105, 1106 may be used for different industrial applications. Changing the windings 1101, 1102, 1103, 1104, 1105, 1106 may result in a stronger connection in downhole drilling. The windings 1101, 1102, 1103, 1104, 1105, 1106 may be configured such that a maximum amount of signal passes through the conical coupler 300.

Whereas the present invention has been described in particular relation to the drawings attached hereto, it should be understood that other and further modifications apart from those shown or suggested herein, may be made within the scope and spirit of the present invention.

What is claimed is:

1. An inductive coupling, comprising;
a pin section comprising an inner electrical conductor supported in an exterior tapered surface of the pin section;
a box section comprising an outer electrical conductor supported in an interior tapered surface of the box section; and
the exterior and interior tapered surfaces are configured to align each other such that the interior and exterior tapered surfaces are coaxial with each other when fully engaged.

2. The coupling of claim 1, wherein when the interior and exterior tapered surfaces are fully engaged the inner and outer electrical conductors are proximate each other such that the inner and outer electrical conductors are in magnetic communication with each other.

3. The coupling of claim 1, wherein the interior tapered surface is configured to contact the exterior tapered surface.

4. The coupling of claim 1, wherein the interior tapered surface is configured to force the exterior tapered surface toward concentricity with the interior tapered surface.

5. The coupling of claim 1, wherein the exterior tapered surface is configured to slide along the interior tapered surface.

6. The coupling of claim 1, wherein the outer electrical conductor is flush with the interior tapered surface.

7. The coupling of claim 1, wherein the inner electrical conductor is flush with the exterior tapered surface.

8. The coupling of claim 1, wherein the pin section and the box section are configured to remain in magnetic communication with each other while they rotate relative to each other.

9. The coupling of claim 1, wherein the inner electrical conductor supported by the exterior tapered surface is in electrical contact with surface equipment.

10. The coupling of claim 1, wherein the outer electrical conductor supported by the interior tapered surface is in electrical contact with downhole equipment.

11. The coupling of claim 1, wherein the pin and box sections comprise an electrically insulating, magnetically conducting material configured to direct a magnetic field formed from the inner and/or outer electrical conductor toward an adjacent conductor.

12. The coupling of claim 11, wherein the electrically insulating, magnetically conducting material is generally U-shaped.

13. The coupling of claim 1, wherein the box section is in mechanical communication with a mechanical member that is configured to translate along a drill string and expand and/or contract an expandable tool.

14. The coupling of claim 13, wherein the box section is attached to the mechanical member, the box section comprises a spring attached to a rearward end of the box section configured to push the box section onto the pin section to maintain the full engagement of the box and pin sections when the mechanical member is translating.

15. The coupling of claim 1, wherein the exterior tapered surface complements the interior tapered surface.

16. The coupling of claim 1, wherein the box section comprises an outer diameter, a portion of the outer diameter is a smaller diameter; the smaller diameter is configured to bend the box section to fully engage the pin section when the pin section contacts the box section at an angle.

17. The coupling of claim 16, wherein the smaller diameter is configured to axially re-center the box and pin sections to adjacent tool components after fully engaging the box and pin sections.

18. The coupling of claim 1, wherein the pin section comprises a protruding guide attached to a distal end of the pin section, a first end of the extremity attaches to a distal end of the pin section and a second end that is tapered configured to help align the pin section to the box section and help fully engage the pin and box sections.

19. The coupling of claim 1, wherein the outer electrical conductor is configured to enter the box section and secure a direct electrical contact with the inner electrical conductor when the pin and box sections are fully engaged.

20. The coupling of claim 1, wherein the interior surface comprises an angle, measured from an axis of the box section, which matches an angle of the exterior surface, measured from an axis of the pin section.
